(19) United States
(12) Patent Application Publication
(10) Pub. No.: US 2005/0010384 A1
(43) Pub. Date: Jan. 13, 2005

(54) Method of simulating fluctuation of oil, program of the same and system of the same

(75) Inventors: Chang Kyu Rheem, Shibuya-ku (JP); Hajime Yamaguchi, Nishitokyo City (JP)

Correspondence Address: OLIFF & BERRIDGE, PLC, P.O. BOX 19928, ALEXANDRIA, VA, 22320, US

(73) Assignee: THE UNIVERSITY OF TOKYO, Tokyo (JP)

(21) Appl. No.: 10/841,541

(22) Filed: May 10, 2004

(30) Foreign Application Priority Data
May 20, 2003 (JP) 2003-142392

(51) Int. Cl. G06G 7/48

(52) U.S. Cl. 703/10

(57) ABSTRACT

A fluctuation of oil in a region is simulated, the region being composed of at least one selected from at least one kinds of liquid inert to the oil and at least one kinds of solid inert to the oil. The region is divided into a plurality of polygonal sections each having the same size and the same shape. A distribution of the oil in each of the polygonal sections is defined as a polygonal oil section. A fluctuation in each of the polygonal oil sections is calculated. The distribution of the oil in each of the polygonal sections is redefined as a polygonal oil section in accordance with the fluctuation of the oil in each of the polygonal oil sections. A certain times of the calculating and the redefining are repeated at a certain regular intervals.

### BACKGROUND OF THE INVENTION

1. Field of the Invention

The present invention relates to a method, a program and a system of simulating a fluctuation of oil in a region composed of at least one selected from at least one kinds of liquid inert to said oil and at least one kinds of solid inert to said oil. The method, program and system may be applied to simulations used, for example, to predict the spread of oil leaked from an oil transporting ship (tanker) passing in a sea region where at least one peaces of ice exist on the surface of the sea. The term “oil” used herein means highly flammable and water-insoluble liquids with various viscosities such as crude oil, kerosene, light oil, heavy oil, gasoline, and so on. The term “being inert to the oil” used herein means not only no chemical reaction to the oil, but also no formation of a uniform liquid or solid resulting from dissolution in the oil or solidification with the oil.

2. Description of the Related Art

The simulation of the fluctuation of the oil has been actively performed since 1960s. The simulation performed from 1960s to early 1970s mainly dealt with the fluctuation of the oil at the open surface of water. Such a simulation is based on Fay's theory considering the circular axial symmetric at the open surface of water as disclosed in Blokker, P. C., “Spreading and Evaporation of Petroleum Products on Water,” Proceedings of 4th International Harbor Congress, Antwerp, 1964, pp. 911-919; Fay, J. A., “The Spread of Oil Slicks on a Calm Sea,” In: “Oil on the Sea,” D. P. Hoult (ed.), Plenum Pub., New York, 1969, pp. 53-64; and Fay, J. A., “Physical Processes in the Spread of Oil in a Water Surface,” Proceedings of Joint Conference on Prevention and Control and Control of Oil Spills,” American Petroleum Institute, Washington, D.C., 1971, pp. 463-467, for example. Fay's theory is based on the simulation of the fluctuation of the oil performed later, and is applied to a real sea region as disclosed in Hoult, D. P., “Oil Spreading on the Sea,” Ann. Rev. of Fluid Mech., 4, 1972, pp. 341-367; Mackay, D., S. Peterson and S. Nadeau, “A Mathematical Model of Oil Spill Behavior,” Environmental Protection Service, Fisheries and Environment Canada, Ottawa, 1980; and Fennelop, T. K. and G. D. Waldman, “Dynamics of Oil Slicks,” American Institute of Aeronaut. and Astronaut. Journal, 10(4), 1972, pp. 506-510, for example.

In 1970s, an oil drilling technique improves in the sea region with ice, so that the move by ship and the transport of the oil by super tanker in winter are generalized, and thus the risk of oil spilling accident gets higher and the simulation of the fluctuation of the oil in the sea region with ice is introduced.

The simulation of the fluctuation of the oil in the sea region with ice is the extended Fay's theory and most of such simulations consider the power balance in the circular axial symmetric spread of the oil. One example of the earlier simulation of the fluctuation of the oil is proposed by Hoult et al. as disclosed in Hoult, D. P. et al., “Oil in the Arctic,” Report No. CG-D-96-75, Prepared for Dept. of Transportation, U.S. Coast Guard, Washington, D.C., 1975, for example. Such a theory formulates a radius of oil spread in accordance with the power balance on the oil. In this situation, the oil is supplied continuously.

Chen et al. propose a formulation of the radius of oil spread when the oil contacts the ice under the balance of buoyancy and viscosity and when water exists between the oil and the ice as disclosed in Chen, E. C., B. E. Keevil and R. O. Ramseier, “Behaviour of Oil Spilled in Ice-Covered Rivers,” Scientific Series No. 60, Envir. Canada Rep., Inland Waters Directorate, Ottawa, 1976, pp. 1-34, for example. As an improved theory in the simulation of the fluctuation of the oil in the sea region with ice, a formulation of the circular axial symmetric spread of the oil in the sea region with ice is proposed by Yapa et al. as disclosed in Yapa, P. D. and T. Chowdhury, “Spreading of Oil Spilled under Ice,” Journal of Hydraulic Engineering, American Society of Civil Engineers, 116(12), 1990, pp. 1268-1483, for example. Yapa made numerous experiments based on his own theory and proved that his own theory corresponds to experiment results.

In conventional simulations of the fluctuation of the oil, however, as a region to be simulated is divided into a plurality of polygonal sections each having the same size and the same shape, a distribution of the oil in each of these polygonal sections is defined as a polygonal oil section, and a movement of the polygonal oil section defined as such for the first time is traced, it is difficult to take in a time change of volume and property of the oil such as new inflow and outflow of the oil and it is also difficult to express the fluctuation in the polygonal oil region changing the volume and the property of the oil in accordance with passage of time.

### SUMMARY OF THE INVENTION

It is the object of the present invention to provide a method, a program and a system of simulating the fluctuation of the oil, which improve the entire accuracy and processing speed of the simulation.

There is provided a method of simulating a fluctuation of oil in a region composed of at least one selected from at least one kinds of liquid inert to the oil and at least one kinds of solid inert to the oil, comprising steps of:
dividing the region into a plurality of polygonal sections each having the same size and the same shape;
defining a distribution of the oil in each of the polygonal sections as a polygonal oil section;
calculating a fluctuation in each of the polygonal oil sections; and
redefining the distribution of the oil in each of the polygonal sections as a polygonal oil section in accordance with the fluctuation of the oil in each of the polygonal oil sections:
a certain times of the steps of calculating and redefining being repeated at a certain regular intervals.

According to the present invention, a fluctuation of oil in a region is simulated, the region being composed of at least one selected from at least one kinds of liquid inert to the oil and at least one kinds of solid inert to the oil. The region is divided into a plurality of polygonal sections each having the same size and the same shape. A distribution of the oil in each of the polygonal sections is defined as a polygonal oil section. A fluctuation in each of the polygonal oil sections is calculated. The distribution of the oil in each of the polygonal sections is redefined as a polygonal oil section in accordance with the fluctuation of the oil in each of the polygonal oil sections. A certain times of the calculating and the redefining are repeated at a certain regular intervals.

By redefining the polygonal oil section periodically, it is possible to take in the time change of volume and property of the oil such as new inflow and outflow of the oil and thus it is possible to express the fluctuation in the polygonal oil region at a relative high accuracy even when the volume and the property of the oil changes in accordance with passage of time and a remarkable large or small polygonal oil occurs.

In order to determine the fluctuation of the polygonal oil region, the step of calculating has, for example, sub-steps of:
determining external force acting on each of sides in a polygon composing the polygonal oil section; and
determining a fluctuation of each of sides in the polygon at a direction normal to each of sides in the polygon based on the external force and determining a fluctuation of the polygonal oil section based on the fluctuation of each of sides in the polygon.

Preferably, the external forces is determined by taking into account frictional force between the liquid and the oil, frictional force between the solid and oil, and frictional force between the oil and gas surrounding the oil. More preferably, each of components in the frictional force between the liquid and the oil, the frictional force between the solid and the oil and the frictional force between the oil and the gas is determined by a gradient of velocity in a vertical direction of a plane composing the polygonal oil section at each of sides in the polygon forming said polygonal oil section, and the component of the frictional force between the liquid and the oil is determined by taking into account a gradient of velocity in water flow at the bottom of the oil, said water flow being occurred because of frictional force against the oil.

In order to redefine the polygonal oil section, the step of redefining has, for example, sub-steps of:
combining all of the fluctuation in each of the polygonal oil section with each other; and
redefining the distribution of the oil in each of the polygonal sections as a polygonal oil section in accordance with the combined fluctuations with the condition of preserving mass, center of mass and momentum of the oil in each of the polygonal oil section.

When the region is composed of a plurality of the solid and the liquid therebeween,
the step of calculating has sub-steps of:
calculating the fluctuation of each of the polygonal oil sections by estimating that the increase of the thickness of the oil flowing among the solids is the volume smaller than the smallest one in the solids surrounding said oil;
calculating the fluctuation of each of the polygonal oil sections by estimating that the increase of the thickness of the oil larger than the largest thickness in the solids surrounds the oil is the volume of the thickness in which the oil can spread over the bottom of the solid;
calculating the fluctuation of each of the polygonal oil sections by estimating the spread of the oil over the bottom of the solid at a constant thickness; and
calculating the fluctuation of each of the polygonal oil sections by estimating the spread of the oil and the increase of the oil after the oil spreads over the bottom of the solid. Thereby, it is possible to determine a relation among the oil, the solid and the liquid at a very high accuracy.

There is also provided that a program of simulating a fluctuation of oil in a region composed of at least one selected from at least one kinds of liquid inert to the oil and at least one kinds of solid inert to the oil, comprising steps of:
dividing the region into a plurality of polygonal sections each having the same size and the same shape;
defining a distribution of the oil in each of the polygonal sections as a polygonal oil section;
calculating a fluctuation in each of the polygonal oil sections; and
redefining the distribution of the oil in each of the polygonal sections as a polygonal oil section in accordance with the fluctuation of said oil in each of the polygonal oil sections:
a certain times of the steps of calculating and redefining being repeated at a certain regular intervals.

Thereby, it is possible to improve the accuracy and processing speed of the entire simulation.

There is also provided that a system of simulating a fluctuation of oil in a region composed of at least one selected from at least one kinds of liquid inert to the oil and at least one kinds of solid inert to the oil, comprising:
means for dividing the region into a plurality of polygonal sections each having the same size and the same shape;
means for defining a distribution of the oil in each of the polygonal sections as a polygonal oil section;
means for calculating a fluctuation in each of the polygonal oil sections; and
means for redefining the distribution of the oil in each of the polygonal sections as a polygonal oil section in accordance with the fluctuation of the oil in each of the polygonal oil sections:
a certain times of the calculating and the defining being repeated at a certain regular intervals.

Thereby, it is possible to improve the accuracy and processing speed of the entire simulation.

### BRIEF DESCRIPTION OF THE DRAWINGS

FIG. 1A is a diagram showing one embodiment according to the present invention of the method, the program and the system of simulating the fluctuation of the oil;

FIG. 1B is a diagram showing a detail of an algorithm simulating the fluctuation of the oil;

FIG. 2 is a diagram explaining the division and the definition of the polygonal sections;

FIG. 3 is a diagram explaining the calculation of the fluctuation in the polygonal oil section in accordance with passage of time;

FIGS. 4A to 4C are diagrams explaining the redefinition of the polygonal oil sections;

FIG. 5A is a diagram explaining the gradient of velocity and the frictional force of the oil at the open surface of the water and the water at the bottom of the sea in a side of the polygonal oil section in an edge of outflow oil region:

FIG. 5B is a diagram explaining these gradient of velocity and frictional force in a side of the continuous polygonal oil sections;

FIGS. 6A to 6D are diagram explaining the simulation of the fluctuation of the oil in a vertical direction among pieces of ice in a region composed of pieces of ice and water therebetween;

FIG. 7 is a diagram showing a simulation result of the spread of the outflow oil when the oil outflows from a certain spot on the surface of the water during a certain time; and

FIGS. 8A to 8D are simulation results of the spread of the outflow oil when the oil outflows from a certain spot on the surface of the sea during a certain time.

### DETAILED DESCRIPTION OF THE PREFERRED EMBODIMENT

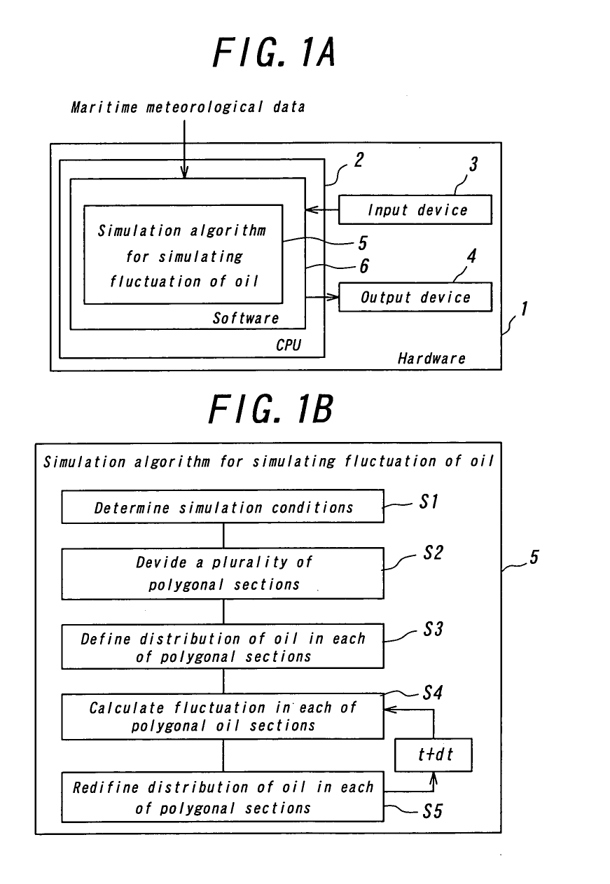

FIG. 1A is a diagram showing one embodiment according to the present invention of the method, the program and the system of simulating the fluctuation of the oil. The system of simulating the fluctuation of the oil according to the present invention is composed of a hardware 1 realized by a general purpose computer, for example. The hardware 1 comprises a central processing unit (CPU) 2, an input device 3 and an output device 4.

In the CPU 2, software 6 with a simulation algorithm 5 for simulating the fluctuation of the oil described below is installed. As to the software 6, oil outflow information is input from the input device 3, maritime meteorological data is input from outside, and a certain times of outflow region fluctuation information described below are output to the output device 4 at a certain interval.

The oil outflow information has an outflow spot of the oil (e. g. the latitude and the longitude of the spot), a kind of the oil (e. g. crude oil, kerosene, light oil, heavy oil, gasoline and so on) and a region performing the simulation (hereinafter, “region”), for example, and is input at the beginning of the simulation. The maritime meteorological data has information about ice in the sea region, wind and tide included in the region, and is input at each time of changing this information.

FIG. 1B is a diagram showing a detail of an algorithm simulating the fluctuation of the oil. This simulation algorithm 5 is one embodiment of the program according to the present invention and performs one embodiment of the method according to the present invention by the CPU 2.

The operation of the embodiment will be described. First, in step S1, simulation conditions are determined. Such simulation conditions includes the region, space resolution for the simulation, simulation time, initial conditions based on the oil outflow information, boundary condition for dividing the region and so on.

Next, in step S2, the region is divided into a plurality of polygonal sections each having the same size and the same shape. In step S3, a distribution of the oil in each of the polygonal sections is defined as a square or rectangular oil section.

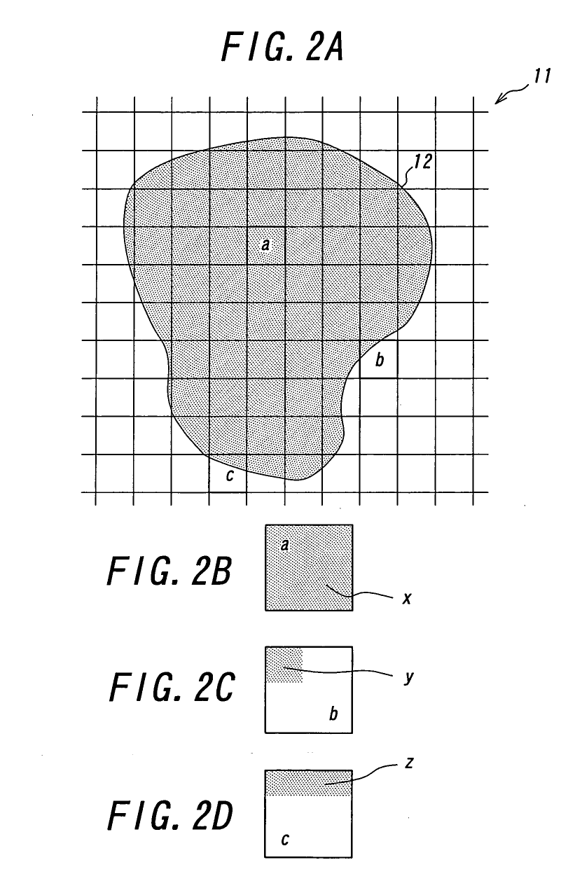

FIG. 2 is a diagram explaining the division and the definition of the polygonal sections. In FIG. 2A, oil 12 is distributed in the region 11 with a plurality of polygonal sections each having the same size and the same shape square. Here, the polygonal oil sections x, y, and z in the polygonal sections a, b and c have a square or a rectangular shape, respectively, and are defined by a length of each sides of the respective sections, a center position of the respective sections, property of the oil and distribution property (in all or a part of the respective sections).

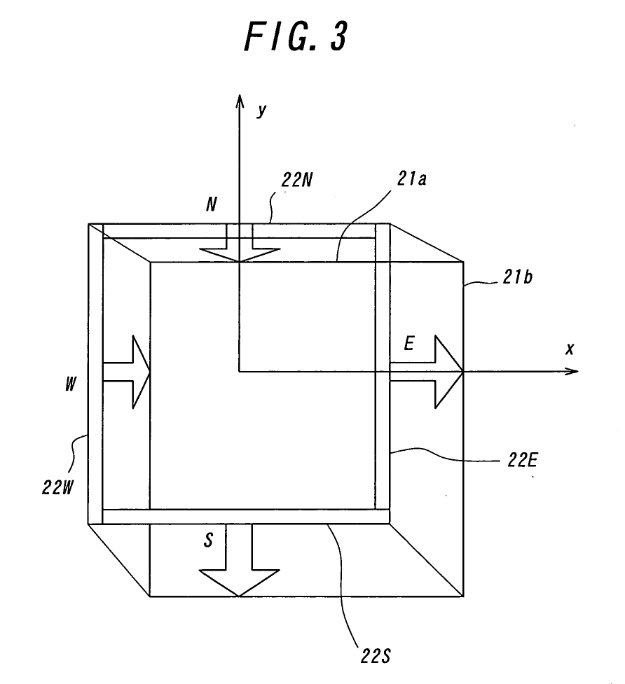

In step S4, a fluctuation in each of the polygonal oil sections is calculated. FIG. 3 is a diagram explaining the calculation of the fluctuation in the polygonal oil section in accordance with passage of time. In FIG. 3, the fluctuation in each of the polygonal oil sections is expressed by movements Δy_{N}, Δx_{E}, Δx_{W}, and Δy_{S} in a direction normal to each sides 22N, 22E, 22W and 22S as shown in Equation 1. A polygonal oil section 21a changes to a polygonal oil section 21b based on these movements Δy_{N}, Δs_{E}, Δx_{W}, and Δy_{S}.

$$Δ {y}_{N} = ( {ν}_{N}^{t} + {ν}_{N}^{t + dt} ) \frac{d t}{2} \\ Δ {x}_{E} = ( {ν}_{E}^{t} + {ν}_{E}^{t + dt} ) \frac{d t}{2} \\ Δ {x}_{W} = ( {ν}_{W}^{t} + {ν}_{W}^{t + dt} ) \frac{d t}{2} \\ Δ {y}_{S} = ( {ν}_{S}^{t} + {ν}_{S}^{t + dt} ) \frac{d t}{2} \qquad [ Equations 1 ]$$

Moving speed in a direction normal to the respective sides 22N, 22E, 22W and 22S is determined by Equation 2 and determines the movements Δy_{N}, Δx_{E}, Δx_{W}, and Δy_{S}.

$${M}_{i} ( {ν}_{i}^{t + d t} - {ν}_{i}^{t} ) = {\sum }_{n} {F}_{i}^{n} ⅆ t \qquad [ Equation 2 ]$$

where Mᵢ represents mass of the oil at the respective sides 22N, 22E, 22W and 22S, and vᵢ represents the moving speed in a direction normal to the respective sides 22N, 22E, 22W and 22S, and Fᵢⁿ represents external force acting on the respective sides 22N, 22E, 22W and 22S (i=N, E, W, S).

The external forces acting on the sides 22N, 22E, 22W and 22S include gravity, surface tension, frictional force against the air, frictional force against water, frictional force against ice, shape resistance result from shape of the respective side 22N, 22E, 22W and 22S, Coriolis' force and so on.

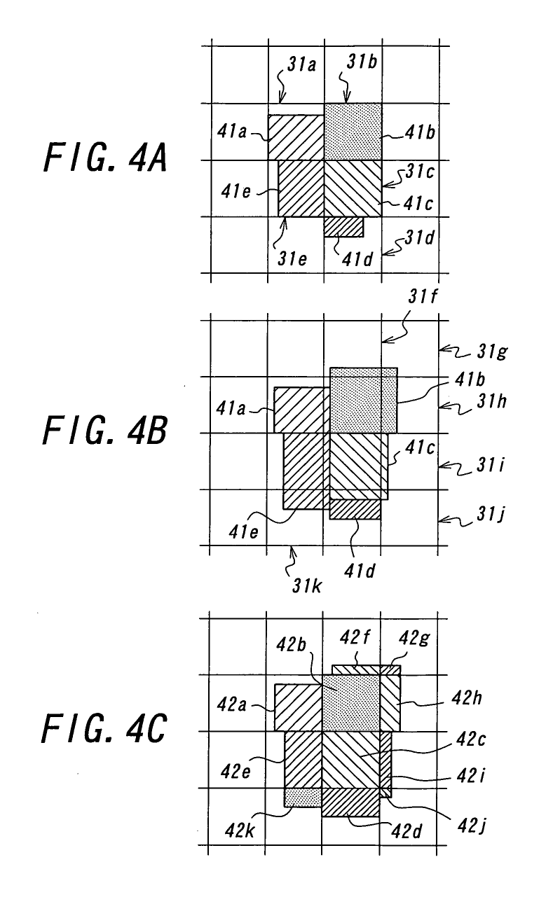

Then, in step S5, the distribution of the oil in each of the polygonal sections is redefined as a square or rectangular oil section in accordance with the fluctuation of the oil in each of the square or rectangular oil sections determined in Step S4. FIGS. 4A to 4C are diagrams explaining the redefinition of the polygonal oil sections. In FIG. 4A, the oil is distributed as each of the square or rectangular oil sections 41a to 41e in polygonal sections 31a to 31e. As shown in FIG. 4B, when a part of the oil in the square or rectangular oil section 41a moves into the polygonal section 31b, a part of the oil in the square or rectangular oil section 41b moves into the polygonal section 31f, 31g and 31h, respectively, a part of the oil in the square or rectangular oil section 41c moves into the polygonal section 31i, 31j and 31d, respectively, and a part of the oil in the square or rectangular oil section 41e moves into the polygonal sections 31c, 31d and 31k, respectively, a part of the square or rectangular oil section 41a and a part of the square or rectangular oil section 41b are integrated together in the polygonal section 31b, and a part of the polygonal oil section 41c and a part of the polygonal oil section 41d are integrated together in the square or rectangular oil section 41d.

After the integration as described above, the distribution of the oil in each of the polygonal sections 31b, 31c and 31d is redefined as square or rectangular oil sections 42b, 42c and 42d with the condition of preserving mass, center of mass and momentum of the oil in each of the polygonal sections 31b, 31c and 31d. After such a redefinition as described above, polygonal sections 31a to 31k have square or rectangular sections 42a to 42k, respectively.

A certain times of Steps S4 and S5 are repeated at a certain regular intervals, and a certain times of the outflow region fluctuation information are output to the output device 4 at a certain regular intervals.

A component of frictional force between at least one kinds of liquid (e. g. seawater or fresh water acting on each sides of the square or rectangular oil section) and the oil, a component of frictional force between at least one kinds of solid (e. g. ice or land) and a component of frictional force between the oil and gas (air) surrounding the oil are determined by a gradient of velocity in a vertical direction of each sides of the square or rectangular oil section. In this case, preferably, a gradient of velocity in water flow at the bottom of the oil is also taken into account. The water flow is occurred because of frictional force against the oil.

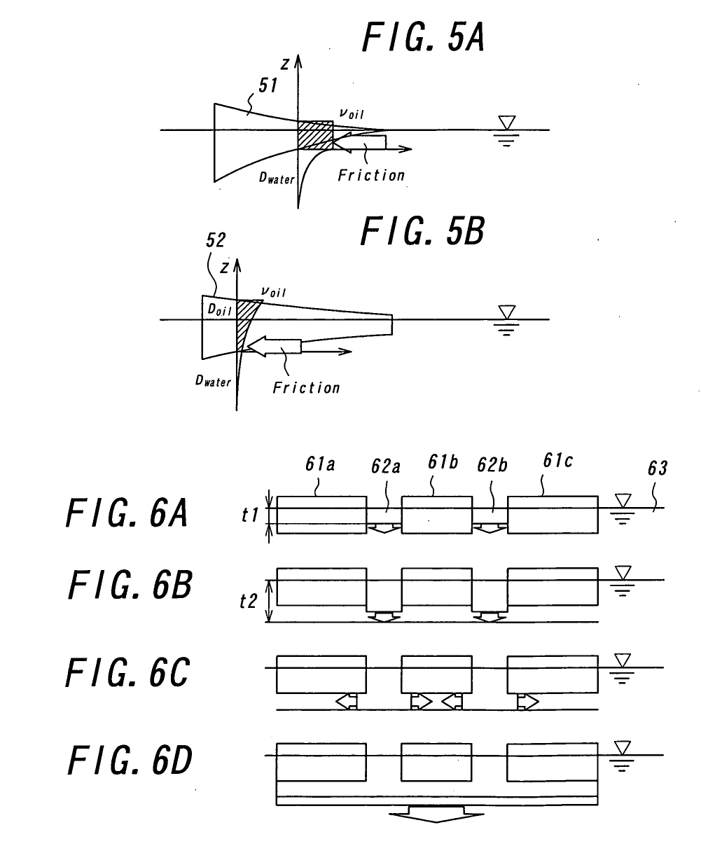

FIG. 5A is a diagram explaining the gradient of velocity and the frictional force of the oil at the open surface of the water and the water at the bottom of the sea in a side of the polygonal oil section in an edge of outflow oil region. In this case, the gradient of velocity νₒᵢₗ (z), ν_{water} (z) and the frictional force τ_{water} of the oil 51 at the open surface of the water and the water at the bottom of the sea are expressed in Equation 3.

$${ν}_{oil} ( z ) = {ν}_{oil} \\ {ν}_{water} ( z ) = {{ν}_{oil} ( O )}_{e}^{π z / {D}_{water}} = {ν}_{oil} {ⅇ}^{π z / {D}_{water}} \\ {τ}_{water} = {μ}_{water} \frac{ⅆ {ν}_{water} ( z )}{ⅆ z} {\vert}_{τ = 0} = {μ}_{water} {ν}_{oil} \frac{π}{{D}_{water}} \qquad [ Equations 3 ]$$

where νₒᵢₗ represents an average velocity of the moving oil in a direction normal to each sides of the square or rectangular oil section (That is, νₒᵢₗ represents moving speed of the oil.), D_{water} represents a thickness of a water flowing layer at the bottom of the oil, the layer is occurred because of friction against the oil, μ_{water} represent a viscosity of water, and νₒᵢₗ (0) represents a velocity of the moving oil at a boundary between the oil and the water.

FIG. 5B is a diagram explaining these gradient of velocity and frictional force in a side of the continuous polygonal oil sections. In this case, the gradient of velocity νₒᵢₗ (z), ν_{water} (z) and the frictional force τ_{water} of the oil 52 at the open surface of the water and the water at the bottom of the sea are expressed in Equation 4.

$${ν}_{oil} ( z ) = {ν}_{oil} ( O ) {ⅇ}^{πz / {D}_{oil}^{ref}} \\ {ν}_{water} ( z ) = {{ν}_{oil} ( O )}_{e}^{πz / {D}_{water}} \\ {D}_{oil}^{ref} = {D}_{water} {μ}_{oil} / {μ}_{water} \\ {τ}_{water} = {μ}_{water} \frac{ⅆ {ν}_{water} ( z )}{ⅆ z} {\vert}_{τ = 0} = {μ}_{water} {ν}_{oil} ( O ) \frac{π}{{D}_{water}} \qquad [ Equations 4 ]$$

where νₒᵢₗ represents an average velocity of the moving oil in a direction normal to each sides of the square or rectangular oil section (That is, νₒᵢₗ represents moving speed of the oil.), D_{water} represents a thickness of a water flowing layer at the bottom of the oil, the layer is occurred because of friction against the oil, μ_{water} represents a viscosity of water, μₒᵢₗ represents a viscosity of the oil, and νₒᵢₗ (0) represents a velocity of the moving oil at a boundary between the oil and the water. In this case, νₒᵢₗ is expressed in Equation 5.

$${ν}_{oil} = \frac{{\int }_{O}^{{D}_{oil}} {ν}_{oil} ( z ) ⅆ {m}_{oil}}{{M}_{oil}} \qquad [ Equation 5 ]$$

FIGS. 6A to 6D are diagram explaining the simulation of the fluctuation of the oil in a vertical direction among pieces of ice in a region composed of pieces of ice and water therebetween. When outflow of the oil occurs, oil 62a flows between ice 61a and ice 61b and oil 62b flows between ice 61c and ice 61d. As the volume of the oil 62a, 62b increases, the oil 62a, 62b moves in a direction represented by arrows and the increase of the thickness t1 of the oil 62a, 62b is estimated (FIG. 6A).

Even if the volume of the oil 62a, 62b further increases and the bottom of the oil 62a, 62b becomes below that of the ice 61a, 61b, 61c, because of the influence of surface tension among the ice 61a, 61b, 61c, the oil 62a, 62b and water 63, the oil 62a, 62b does not spread toward a direction at the bottom of the ice 61a, 61b, 61c, and the increase of the thickness t2 of the oil 62a, 62b is estimated. At the thickness t2, it is possible to spread along the bottom of the ice 61a, 61b, 61c (FIG. 6B).

The thickness t2 becomes the thickness of the oil 62a, 62b in which the surface tension is balanced to force spreading by gravity.

When the thickness of the oil 62a, 62b exceeds the thickness t2, the spread of the oil 62a, 62b in a direction at the bottom of the ice 61a, 61b, 61c is estimated (FIG. 6C). In this case, the thickness of the oil 62a, 62b is kept to the thickness t2. When the oil 62a, 62b spreads all over the bottom of the ice 61a, 61b, 61c, the increase of the spread and the thickness of the oil 62a, 62b is estimated (FIG. 6D).

The relation among the ice 61a, 61b, the oil 62a, 62b and the water 63 is important when a moving speed in each sides of the square or rectangular oil section. In the stage of estimating the spread of the oil 62a, 62b in a direction at the bottom of the ice 61a, 61b, 61c as shown in FIG. 6C, the fluctuation of the oil in the square or rectangular oil section is calculated based on the fluctuation of the oil 62a between the ice 61a and the ice 61b and that of the oil 62b between the ice 61b and the ice 61c. In the stage of estimating the spread and the thickness of the oil 62a, 62b after the oil 62a, 62b spreads all over the bottom of the ice 61a, 61b, 61c as shown in FIG. 6D, the fluctuation of the oil in the square or rectangular oil section is calculated based on a correlation of the fluctuation of the oil 62a between the ice 61a and the ice 61b, the fluctuation of the oil 62b between the ice 61b and the ice 61c, and the fluctuation of the oil 62a, 62b at the bottom of the ice 61a, 61b, 61c.

When the thickness of the oil 62a, 62b decreases so that the oil 62a, 62b spreads in a direction at the bottom of the ice 61a, 61b, 61c remarkably, the fluctuation of the oil 62a, 62 is the opposite to that when the thickness of the oil 62a, 62b increases. In process of decreasing the thickness of the oil 62a, 62b, a part of the oil 62a, 62b will be left in a convex or concave portion at the bottom of the ice 61a, 61b, 61c. When the oil 62a, 62b is distributed around the ice 61a, 61b, 61c for a relatively long time, a part of the oil 62a, 62b will adhere to the ice 61a, 61b, 61c.

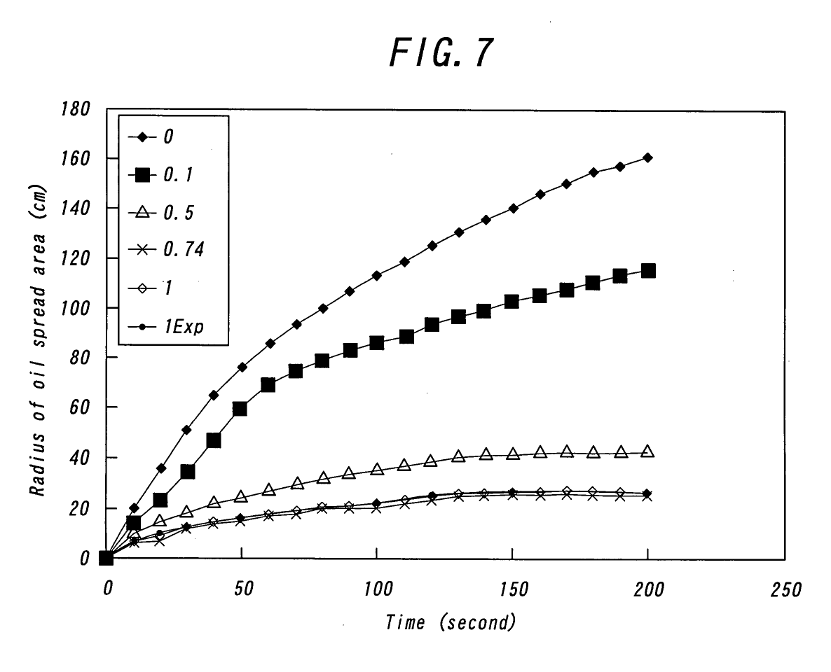

FIG. 7 is a diagram showing a simulation result of the spread of the outflow oil when the oil outflows from a certain spot on the surface of the water during a certain time. The simulation conditions are as follows;
Kind of oil: lubricating oil for machines (density: 0.878 g/cm³, dynamic viscosity: 2.89 cm²/sec)
Flow rate of outflow oil: 24 cm³/sec, Outflow time: 124 sec
Volume of ice: Surface area of ice relative to that of water 0 (open water: ♦), 0.1 (▪), 0.5 (Δ), 0.74 (X), and 1.0 (ice-covered surface: □)
Thickness of ice: 0.5 cm, size of ice: 3 cm
Surface tension among ice, water and oil: 100 dyne/cm, surface tension among air, water and oil: 20 dyne/cm

As shown in FIG. 7, a spreading speed of the oil decreases as the volume of the ice on the surface of the water increases because of the influence of friction against the ice. In the simulation conditions as described above, the spread of the ice is the smallest when the surface area of ice relative to that of water is 0.74 because the movement of the oil is restricted by the frictional force of the ice and the oil inflows among a plurality of pieces of ice.

The simulation result when the ice covers all over the surface of the water corresponds to the experimental result (1 Exp, ●). The experimental result is based on K. Izumiyama et al., “Experimental and Theoretical Analysis of the Spread of Oil Spills in an Icy Sea Region (Japanese),” Proceedings of Seashore Engineering, 45, 1988, pp. 921-925.

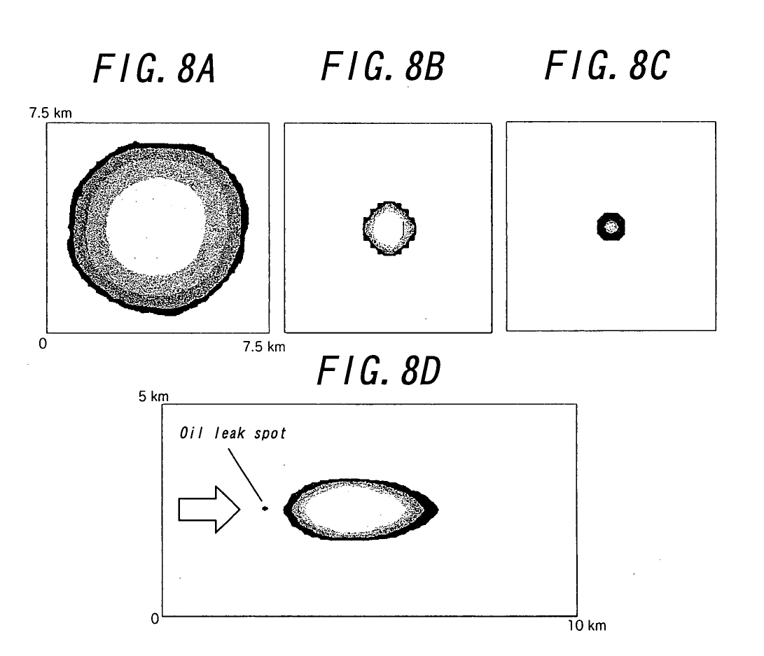

FIGS. 8A to 8D are simulation results of the spread of the outflow oil when the oil outflows from a certain spot on the surface of the sea during a certain time. In this case, a two-dimensional simulation was performed and property change of the outflow oil is considered. The simulation conditions are as follows;
Kind of oil: Iranian light oil (specific gravity: 0.86, initial viscosity: 80 cst, final viscosity: 3000 cst)
Flow rate of outflow oil: 1 m³/sec, Outflow time: 1 day, Total volume of outflow: 86,400 m³
Volume of ice: Surface area of ice relative to that of water 0 (open water), 0.4, and 1.0
Size of polygonal section: 250 m×250 m

FIGS. 8A to 8C show the simulation results of the spread of the outflow oil when the surface area of the ice relative to that of the water is 0, 0.4 and 1.0, respectively, provided that there is no movement of the ice (on the sea) and the (sea)water. FIGS. 8A to 8C represent an effect of restricting the spread by the ice. FIG. 8D shows the simulation result of the spread of the outflow oil provided that the ice (on the sea) and the (sea)water flow at a constant speed of moving (1 cm/sec) in a direction as indicated in an arrow. FIG. 8D represents an influence of the flow of the ice and the water on the spread of the outflow oil.

While the present invention has been described above with reference to a certain preferred embodiment, it should be noted that it was present by way of an examples only and various changes and/or modifications may be made without departing from the scope of the invention.

For example, as the liquid, any other kinds of liquid than the seawater or the fresh water may be used, as the solid, any other kinds of solid (e. g. an island, asphalt and so on) than the ice may be used, as the oil outflow information, any other information than the outflow spot of the oil, a kind of the oil and the region performing the simulation may be included therein, and as the maritime meteorological data, any other information than the ice in the sea region, the wind and the tide included in the region may be included therein.

The fluctuation of each of the sides in the polygon oil section may be determined without using Equation 1, and the moving speed of each of the sides in the polygonal oil section may be determined without using Equation 2. Also, the polygonal section may be composed of any other polygon than the square or the rectangular, and the polygonal oil section may be composed of any other polygon than the square or the rectangular. The components of the frictional force between at least one kind of the liquid (such as the seawater and the fresh water) and the oil, the frictional force between at least one kind of the solid (such as the ice and the land) and the oil, and the frictional force between the oil and the gas surrounding the oil acting on each of the sides in each of the polygonal oil sections as well as the gradient of velocity in a direction normal to each of the sides in each of the polygonal oil sections may be determined without using Equations 3 and 4.

1. A method of simulating a fluctuation of oil in a region composed of at least one selected from at least one kinds of liquid inert to said oil and at least one kinds of solid inert to said oil, comprising steps of:
dividing said region into a plurality of polygonal sections each having the same size and the same shape;
defining a distribution of said oil in each of said polygonal sections as a polygonal oil section;
calculating a fluctuation in each of said polygonal oil sections; and
redefining said distribution of said oil in each of said polygonal sections as a polygonal oil section in accordance with said fluctuation of said oil in each of said polygonal oil sections:
a certain times of said steps of calculating and redefining being repeated at a certain regular intervals.

2. The method according to claim 1, wherein said step of calculating has sub-steps of:
determining external force acting on each of sides in a polygon composing said polygonal oil section; and
determining a fluctuation of each of sides in said polygon at a direction normal to each of sides in said polygon based on said external force and determining a fluctuation of said polygonal oil section based on said fluctuation of each of sides in said polygon.

3. The method according to claim 2, wherein said external forces is determined by taking into account frictional force between said liquid and said oil, frictional force between said solid and said oil, and frictional force between said oil and gas surrounding said oil.

4. The method according to claim 3, wherein each of components in said frictional force between said liquid and said oil, said frictional force between said solid and said oil and said frictional force between said oil and said gas is determined by a gradient of velocity in a vertical direction of a plane composing said polygonal oil section at each of sides in said polygon forming said polygonal oil section.

5. A method according to claim 4, wherein said component of the frictional force between said liquid and said oil is determined by taking into account a gradient of velocity in water flow at the bottom of said oil, said water flow being occurred because of frictional force against said oil.

6. The method according to claim 1, wherein said step of redefining has sub-steps of:
combining all of said fluctuation in each of said polygonal oil section with each other; and
redefining said distribution of said oil in each of said polygonal sections as a polygonal oil section in accordance with the combined fluctuations with the condition of preserving mass, center of mass and momentum of said oil in each of said polygonal oil section.

7. The method according to claim 1, wherein said region is composed of a plurality of said solid and said liquid therebeween,
said step of calculating has sub-steps of:
calculating said fluctuation of each of said polygonal oil sections by estimating that the increase of the thickness of said oil flowing among said solids is the volume smaller than the smallest one in said solids surrounding said oil;
calculating said fluctuation of each of said polygonal oil sections by estimating that the increase of the thickness of said oil larger than the largest thickness in said solids surrounds said oil is the volume of the thickness in which said oil can spread over the bottom of said solid;
calculating said fluctuation of each of said polygonal oil sections by estimating the spread of said oil over the bottom of said solid at a constant thickness; and
calculating said fluctuation of each of said polygonal oil sections by estimating the spread of said oil and the increase of said oil after said oil spreads over the bottom of said solid.

8. A program of simulating a fluctuation of oil in a region composed of at least one selected from at least one kinds of liquid inert to said oil and at least one kinds of solid inert to said oil, comprising steps of:
dividing said region into a plurality of polygonal sections each having the same size and the same shape;
defining a distribution of said oil in each of said polygonal sections as a polygonal oil section;
calculating a fluctuation in each of said polygonal oil sections; and
redefining said distribution of said oil in each of said polygonal sections as a polygonal oil section in accordance with said fluctuation of said oil in each of said polygonal oil sections:
a certain times of said steps of calculating and redefining being repeated at a certain regular intervals.

9. The program according to claim 8, wherein said step of calculating has sub-steps of:
determining external force acting on each of sides in a polygon composing said polygonal oil section; and
determining a fluctuation of each of sides in said polygon at a direction normal to each of sides in said polygon based on said external force and determining a fluctuation of said polygonal oil section based on said fluctuation of each of sides in said polygon.

10. The program according to claim 9, wherein said external forces is determined by taking into account frictional force between said liquid and said oil, frictional force between said solid and said oil, and frictional force between said oil and gas surrounding said oil.

11. The program according to claim 10, wherein each of components in said frictional force between said liquid and said oil, said frictional force between said solid and said oil and said frictional force between said oil and said gas is determined by a gradient of velocity in a vertical direction of a plane composing said polygonal oil section at each of sides in said polygon forming said polygonal oil section.

12. The program according to claim 11, wherein said component of the frictional force between said liquid and said oil is determined by taking into account a gradient of velocity in water flow at the bottom of said oil, said water flow being occurred because of frictional force against said oil.

13. The program according to claim 8, wherein said step of redefining has sub-steps of:
combining all of said fluctuation in each of said polygonal oil section with each other; and
redefining said distribution of said oil in each of said polygonal sections as a polygonal oil section in accordance with the combined fluctuations with the condition of preserving mass, center of mass and momentum of said oil in each of said polygonal oil section.

14. A program according to claim 8, wherein said region is composed of a plurality of said solid and said liquid therebeween,
said step of calculating has sub-steps of:
calculating said fluctuation of each of said polygonal oil sections by estimating that the increase of the thickness of said oil flowing among said solids is the volume smaller than the smallest one in said solids surrounding said oil;
calculating said fluctuation of each of said polygonal oil sections by estimating that the increase of the thickness of said oil larger than the largest thickness in said solids surrounds said oil is the volume of the thickness in which said oil can spread over the bottom of said solid;
calculating said fluctuation of each of said polygonal oil sections by estimating the spread of said oil over the bottom of said solid at a constant thickness; and
calculating said fluctuation of each of said polygonal oil sections by estimating the spread of said oil and the increase of said oil after said oil spreads over the bottom of said solid.

15. A system of simulating a fluctuation of oil in a region composed of at least one selected from at least one kinds of liquid inert to said oil and at least one kinds of solid inert to said oil, comprising:
means for dividing said region into a plurality of polygonal sections each having the same size and the same shape;
means for defining a distribution of said oil in each of said polygonal sections as a polygonal oil section;
means for calculating a fluctuation in each of said polygonal oil sections; and
means for redefining said distribution of said oil in each of said polygonal sections as a polygonal oil section in accordance with said fluctuation of said oil in each of said polygonal oil sections:
a certain times of said calculating and said defining being repeated at a certain regular intervals.

16. The system according to claim 15, wherein said means for calculating has:
means for determining external force acting on each of sides in a polygon composing said polygonal oil section; and
means for determining a fluctuation of each of sides in said polygon at a direction normal to each of sides in said polygon based on said external force and determining a fluctuation of said polygonal oil section based on said fluctuation of each of sides in said polygon.

17. The system according to claim 16, wherein said external forces is determined by taking into account frictional force between said liquid and said oil, frictional force between said solid and said oil, and frictional force between said oil and gas surrounding said oil.

18. The system according to claim 17, wherein each of components in said frictional force between said liquid and said oil, said frictional force between said solid and said oil and said frictional force between said oil and said gas is determined by a gradient of velocity in a vertical direction of a plane composing said polygonal oil section at each of sides in said polygon forming said polygonal oil section.

19. The system according to claim 18, wherein said component of the frictional force between said liquid and said oil is determined by taking into account a gradient of velocity in water flow at the bottom of said oil, said water flow being occurred because of frictional force against said oil.

20. The system according to claim 15, wherein said means for redefining has:
means for combining all of said fluctuation in each of said polygonal oil section with each other; and
means for redefining said distribution of said oil in each of said polygonal sections as a polygonal oil section in accordance with the combined fluctuations with the condition of preserving mass, center of mass and momentum of said oil in each of said polygonal oil section.

21. The system according to claim 15, wherein said region is composed of a plurality of said solid and said liquid therebeween,
said means for calculating has:
means for calculating said fluctuation of each of said polygonal oil sections by estimating that the increase of the thickness of said oil flowing among said solids is the volume smaller than the smallest one in said solids surrounding said oil;
means for calculating said fluctuation of each of said polygonal oil sections by estimating that the increase of the thickness of said oil larger than the largest thickness in said solids surrounds said oil is the volume of the thickness in which said oil can spread over the bottom of said solid;
means for calculating said fluctuation of each of said polygonal oil sections by estimating the spread of said oil over the bottom of said solid at a constant thickness; and
means for calculating said fluctuation of each of said polygonal oil sections by estimating the spread of said oil and the increase of said oil after said oil spreads over the bottom of said solid.
